(19) United States
(12) Patent Application Publication
(10) Pub. No.: US 2011/0268245 A1
(43) Pub. Date: Nov. 3, 2011

(54) MULTIPLE BEAM LINE TOMOSYNTHESIS IMAGING

(75) Inventor: Jeffrey Wayne Eberhard, Albany, NY (US)

(73) Assignee: GENERAL ELECTRIC COMPANY, Schenectady, NY (US)

(21) Appl. No.: 12/771,531

(22) Filed: Apr. 30, 2010

(51) Int. Cl. H05G 1/60

(52) U.S. Cl. 378/5

(57) ABSTRACT

A method of imaging an object includes providing a stationary x-ray tube, that is configured to emit a cone beam of x-rays, wherein a line extending from the x-ray tube and through the object defines a tomographic angle and a beamline, further wherein the x-ray tube is configured to emits x-rays from several tomographic angles; providing a system controller configured to operate the x-ray tube; locating at least one flat-panel area detector opposite the x-ray tube, thereby defining a field of view, wherein flat-panel area detector(s) is configured to receive the emitted x-rays from the different tomographic angles, further wherein the detector(s) comprise an array of L×W detector elements; conveying the object along the path of travel; and selectively emitting x-rays from the x-ray tube in the tomographic angles through the object, wherein each beamline emitted from the x-ray tube impinges on a different portion of the flat-panel area detector.

### BACKGROUND OF THE INVENTION

The present invention relates generally to tomosynthesis imaging and more particularly to various systems and methods for providing multiple beam line tomosynthesis imaging.

Current x-ray imaging systems have several limitations. Amongst these are low sensitivity, high false-positive rates, and difficulty in interpreting images by the operators and/or analysts.

Attempts at solutions include multi-view imaging and dual energy imaging. Typically existing systems simply acquire a single projection image of the object of interest from each beam line. While imaging systems may address one of the limitations, a technical difficulty is in designing a system that improves upon multiple limitations while concurrently having reasonable manufacturing and operating costs as well as ease of operator use.

Accordingly, there is an ongoing need for improvement in imaging technology and its methodologies.

### BRIEF DESCRIPTION

In accordance with an embodiment of the invention, a method of imaging an object comprises: providing a stationary x-ray tube, wherein the stationary x-ray tube is configured to emit a cone beam of x-rays therefrom, further wherein a line extending from the stationary x-ray tube and through the object defines a tomographic angle, further wherein the stationary x-ray tube is configured to emits x-rays from a plurality of tomographic angles; providing a system controller configured to operate the stationary x-ray tube; locating one of a plurality of linear detectors and a flat-panel area detector opposite the stationary x-ray tube, thereby defining a field of view, wherein the plurality of linear detectors and a flat-panel area detector are configured to receive the emitted x-rays from the plurality of tomographic angles; conveying the object through the field of view along a path of travel; and intermittently emitting x-rays from the stationary x-ray tube in the plurality of tomographic angles through the object in the field of view.

In accordance with another embodiment of the invention, a method of imaging an object comprises: providing a stationary x-ray tube, wherein the stationary x-ray tube is configured to emit a cone beam of x-rays therefrom, further wherein a line extending from the stationary x-ray tube and through the object defines a tomographic angle and a beamline, further wherein the stationary x-ray tube is configured to emits x-rays from a plurality of tomographic angles; providing a system controller configured to operate the stationary x-ray tube; locating at least one flat-panel area detector opposite the stationary x-ray tube, thereby defining a field of view, wherein the at least one flat-panel area detector is configured to receive the emitted x-rays from the plurality of tomographic angles, further wherein the at least one flat-panel area detector comprises an array of L×W detector elements, wherein L is a length along a path of travel and W is a width transverse to the path of travel; conveying the object through the field of view along the path of travel; and selectively emitting x-rays from the stationary x-ray tube in the plurality of tomographic angles through the object in the field of view, wherein each beamline emitted from the stationary x-ray tube impinges on a different portion of the flat-panel area detector.

These and other advantages and features will be more readily understood from the following detailed description of preferred embodiments of the invention that is provided in connection with the accompanying drawings.

### BRIEF DESCRIPTION OF THE DRAWINGS

FIG. 1 is a block diagram depicting an exemplary tomosynthesis imaging system, in accordance with aspects of the present invention;

FIG. 2 is an end elevation view of an exemplary tomosynthesis imaging system, in accordance with aspects of the present invention;

FIGS. 3A and 3B depict top views of various detector embodiments used in exemplary tomosynthesis imaging systems, in accordance with aspects of the present invention;

FIG. 4 is a side elevation view of a portion of an exemplary tomosynthesis imaging system, in accordance with aspects of the present invention;

FIG. 5 is a side elevation view of a portion of another exemplary tomosynthesis imaging system, in accordance with aspects of the present invention;

FIG. 6 is a side elevation view of a portion of another exemplary tomosynthesis imaging system, in accordance with aspects of the present invention; and,

FIG. 7 is a flowchart of an exemplary method of imaging an object, in accordance with aspects of the present invention.

### DETAILED DESCRIPTION

As discussed in detail herein, embodiments of the invention include a multiple beam line tomosynthesis imaging system and method. The present technique is generally directed to the use of imaging techniques to generate more useful images, such as for inspection or other security or non-security (e.g., medical) applications. In general, tomosynthesis imaging techniques allow for the reconstruction of a volumetric data set from an incomplete set of projection images, i.e., insufficient projection images to fill Radon space. In the context of the present technique, multiple projection images may be acquired at different orientations relative to an imaged object, such as a human body or an article of luggage. The projection images may then be processed to generate a volumetric dataset, which may be used for the, analysis, visualization and display of selected volumes of image data. In a security context the image data may provide information, such as three-dimensional context, that is unavailable in standard security inspection checkpoints. As will be appreciated by those of ordinary skill in the art, the present techniques may also be applied in other security and non-security contexts, such as for medical examinations, to provide useful three-dimensional data and context. To facilitate explanation of the present techniques, however, an airport-type security implementation will be generally discussed herein, though it is to be understood that other security and non-security implementations are also within the scope of the present techniques.

An object of aspects of the invention is to provide high performance contraband detection imaging capability for access control of secure areas. Objects to be screened include those where contraband can be concealed inside: handbags, briefcases, backpacks, suitcases, shipping boxes, shipping containers, and the like. Checked bag inspection in the airport as well as checkpoint inspection and cargo inspection are potential applications.

An objective of aspects of the present invention is to simultaneously provide a high probability of detection with a low false alarm rate. Additional objectives may include fast operation, compact system footprint, acceptable capital and running costs, ease of use, high reliability, and the like.

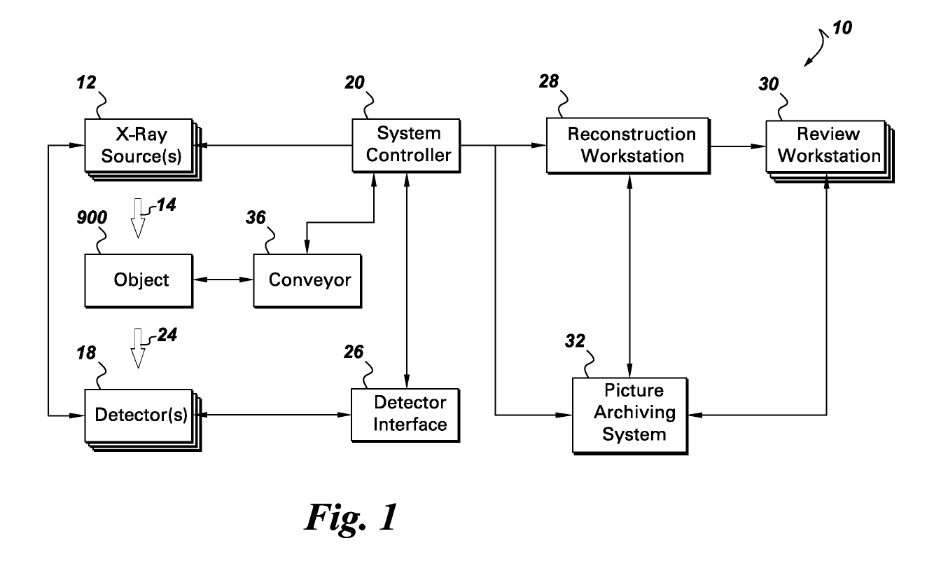

An exemplary multiple beam line tomosynthesis imaging system, or imaging system, 10 for use in conjunction with the present method is depicted in FIG. 1 as a block diagram. As depicted the imaging system 10 may include a one or more X-ray sources 12, which may comprise one or more emission points or producers of X-ray radiation 14. For example, the one or more X-ray sources 12 may comprise an X-ray tube and generator configured to each generate a beam of X-rays 14 when activated. In addition, the one or more X-ray sources 12 may be movable in one, two or three dimensions, either by manual or by automated means, such that the position of an emission point may be changed with respect to an object 900 and/or a detector 18. As noted above, the one or more X-ray sources 12 may include multiple X-ray producing components, such as X-ray tubes, or X-ray emission points, such as field emitters of a solid-state source, disposed at the desired orientations about the object 900. Where the X-ray source 12 includes multiple emission points, the individual activation of the emission points in a desired sequence may functionally equate to the physical movement of an individual emission point relative to the imaged anatomy. Therefore, those of ordinary skill in the art will appreciate that, as discussed herein, moving an X-ray source 12 and/or emission point may be accomplished by the physical movement of an X-ray emitter, by activating two or more such emitters in a sequence that equates to such physical movement, or by some combination of these approaches.

The system 10 further comprises one or more X-ray detectors 18 each configured to detect X-rays emitted 24 by at least one corresponding X-ray source 12 of the one or more X-ray sources 12 and to generate signals in response to the detected X-rays. In alternative embodiments, more than one detector 18 can be configured to receive X-rays emitted from a single X-ray source 12 (i.e., many-to-one relationship). Similarly, each X-ray source 12 may have only a single corresponding X-ray detector 18 (i.e., one-to-one relationship) from which it received emitted X-rays. In one embodiment, at least one detector 18 receiving X-rays from multiple sources 12, as well as the associated sources 12, may be operated in a multiplexed manner. It should be apparent to one skilled in the art that other variations are possible without departing from aspects of the present invention including, for example, a combination of any of the aforementioned features.

Activation of the one or more X-ray sources 12 may be controlled by a system controller 20 which may control the activation and operation, including collimation, of the one or more X-ray sources 12. In particular, the system controller 20 may be configured to provide power and timing signals to the one or more X-ray sources 12. In addition, the system controller 20 may control the motion of the one or more X-ray sources 12 and/or the one or more detectors 18 in accordance with a pre-configured or operator selected imaging trajectory. The system controller 20 may also execute various signal processing and filtration functions, such as for initial adjustment of dynamic ranges, interleaving of digital image data, and so forth. In general, system controller 20 commands operation of the imaging system 10 to execute examination protocols and to acquire the resulting data.

Other elements of the system 10, as shown in FIG. 1, comprise the system controller 20, detector interface 26, reconstruction workstation 28, review workstation 30, and picture archiving system 32. The review workstation 30 may comprise a plurality of review workstations 30. In an embodiment, the system 10 will include a review workstation 30 for each of the beamlines of the system 10. For example, there may be two or three beamlines in the system 10, and, thus, two or three review workstations 30 in the system 10. Exemplary configurations and relationships of these various elements are described in detail in the reference having the common assignee, namely U.S. Pat. No. 7,142,633, filed Mar. 31, 2004, entitled “Enhanced X-ray Imaging System and Method,” the entire contents of which are hereby incorporated by reference.

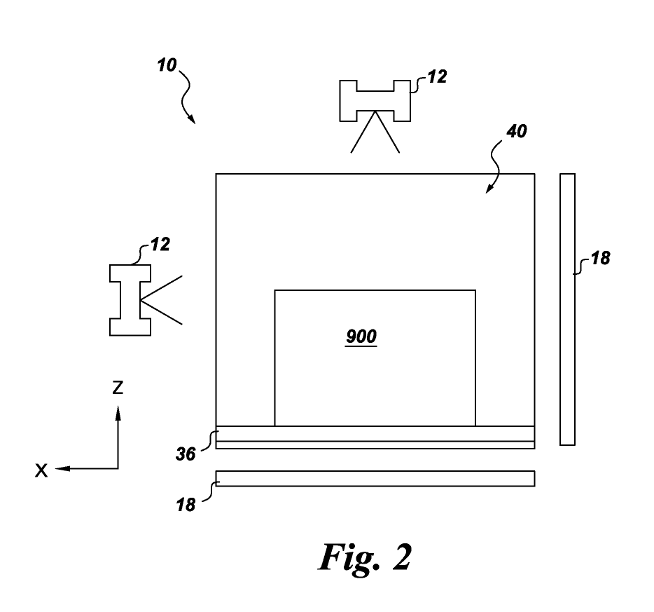

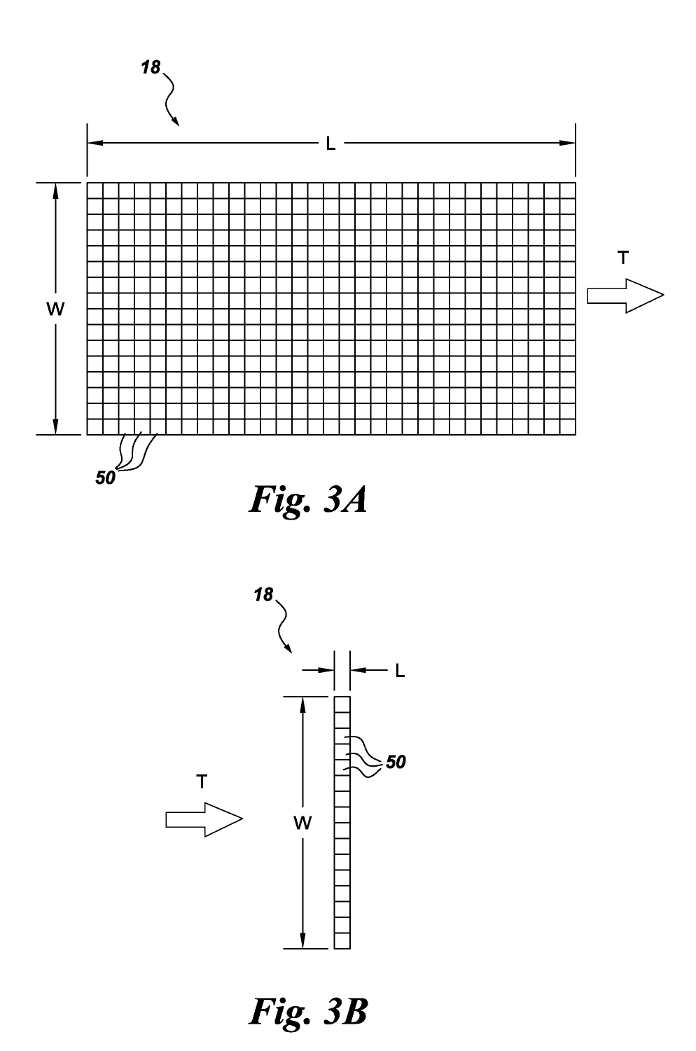

The system 10 may further comprise an object conveyance device, or conveyor, 36 that is configured to transport the object 900 along an axis, or path, of travel through an imaging volume 40 (see e.g., FIG. 2) between the one or more X-ray sources 12 and one or more detectors 18. The conveyor 36 conveys objects 900 through the system 10 in the axis or path of travel, as denoted by directional arrow “T” (See e.g., FIGS. 3A and 3B).

FIG. 2 offers an end view of a portion of an exemplary tomosynthesis imaging system 10, in accordance with aspects of the present invention. For clarity purposes, only two X-ray sources 12 are shown with their corresponding X-ray detectors 18 with a conveyor 36 for transporting an object 900 along a Y-axis (i.e., into the plane of the figure). Thus, FIG. 2 shows a dual-beam configuration wherein the projection direction between source 12 and corresponding detector 18 is transverse to the path, or axis, of travel. In other embodiments, other beam configurations may be used. For example, the quantity of X-ray sources 12 may be in a range from one to about ten. A typical quantity of X-ray sources 12 may comprise two or three each in a system 10. Similarly, the quantity of detectors 18 may be in a range from one to about thirty (30). A typical quantity of detectors 18 may be from about two (2) to about fifteen (15) per X-ray beamline.

Referring to FIGS. 3A and 3B, top views of exemplary types of detectors 18 which may be employed under aspects of the present invention are depicted. For example, a large area array detector 18 (FIG. 3A) may be used which comprises a plurality of detector elements 50 arranged in an array having a length (shown as “L”) and a width (shown as “W”). Directional arrow “T” shows the direction of the path of travel of the object 900 along the conveyor 36 through the system 10. The large area array detector 18 may comprise a near infinite quantity of detector elements 50. For example, the length (L) and width (W) of an embodiment may be a range of about 250 to about 2,000 detector elements 50. The actual length (L) may be in a range from about one foot to about 2 meters. The actual width (W) may be in a range from about one foot to about 0.5 meters. The length and width may be equal in distance and quantity of detectors 50 (i.e., square-shaped large area array detector 18), or the length and width may be different in distance and quantity of detectors 50 (i.e., rectangular-shaped large area array detector 18). Similarly, the total quantity of detector elements 50 may be in a range of about 250 to about 6,000 detector elements 50 in each direction (L and W). It should be obvious to one skilled in the art that other quantities, sizes, and configurations of detector elements 50 may be used in embodiments of the present invention without departing from the invention.

In other embodiments, a plurality of large area array detectors 18 may be adjoined or abutted, thereby increasing the total effective detecting area of the system 10. For example, three separate large area array detectors 18, each being 0.5 meter wide (W) and 0.5 meter long (L), may be used so that the total effective detecting area of the system 10 is 0.5 wide (W) and 1.5 meters long (L).

Similarly, a linear detector 18 (FIG. 3B) may be used. The linear detector 18 comprises a plurality of detector elements 50 arranged in a linear configuration having a length (shown as “L”) of one detector element 50 and a width (shown as “W”) of about 250 to about 2,000 detector elements 50. Directional arrow “T” shows the direction of the path of travel of the object 900 along the conveyor 36 through the system 10. It should be apparent to one skilled in the art that other variations are possible without departing from aspects of the present invention including, for example, a system 10 that includes a combination of any of the aforementioned features.

Various types of sources 12 and detectors 18 may be used under aspects of the present invention. For example, the system 10 may be configured to operate at multiple X-ray energies. Similarly, the sources 12 may be configured so that at least two of the X-ray sources 12 emit different spectra energy. Alternatively, the sources 12 may be configured so that at least one of the X-ray sources 12 emits at least two different energy spectra. In another embodiment, at least one of the detectors 18 may comprise an energy sensitive detector. For example, the source(s) 12 may operate at about 100 kVp and about 180 kVp. In this manner, the system 10 offers a dual-energy capability which assists in removing material and/or density ambiguities.

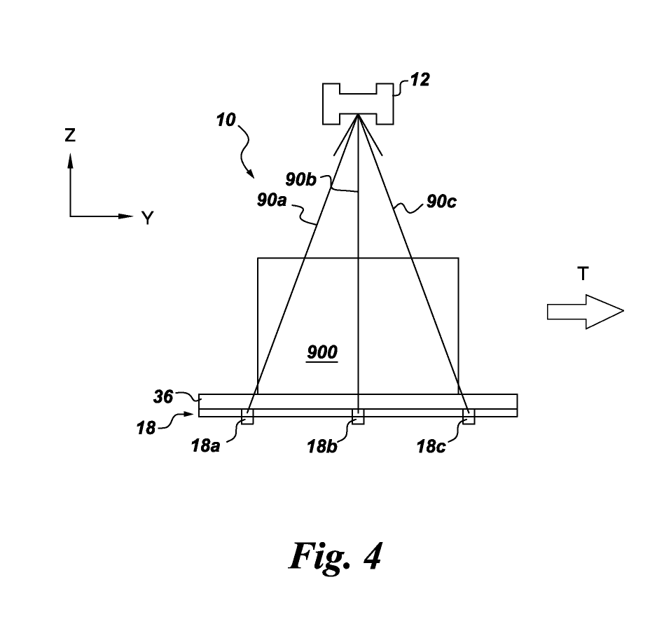

Depending on the particular embodiment (e.g., type of detectors 18 used) and method of operation thereof, the inventor has termed various embodiments, respectively, Linear Detector Mode, Area Detector Mode, and Area Detector Mode in Linear Detector Mode. Referring to FIGS. 4-6, side elevation views of a portion of exemplary tomosynthesis imaging systems 10 employing one or more of these modes, in accordance with aspects of the present invention are depicted.

Referring to FIG. 4, the side elevation view depicts one X-ray source 12 capable of emitting a plurality of X-ray beams from various tomographic angles through the object 900 being transported by conveyor 36 in a direction of travel, T. The embodiment shown is in the linear detector mode of operation. In this embodiment, the system 10 comprises a plurality (e.g., three) of linear detectors 18a, 18b, 18c spaced along the path of travel, beneath the conveyor 36. The x-ray source 12 is configured to emit a plurality of x-ray beams from a variety of tomographic angles (i.e., tomo angles) towards the object 900 as it travels along the conveyor 36. For example, a first X-ray beam “shot” 90a from a first tomographic angle may be aimed at a first linear detector 18a. A second X-ray beam “shot” 90b from a second tomographic angle may be aimed at a second linear detector 18b. A third X-ray beam “shot” 90c from a third tomographic angle may be aimed at a third linear detector 18c. The mode may further include the ability of the X-ray source 12 to intermittently emit X-ray beams in at least two different energy spectra or each linear detector 18a, 18b, 18c has a dual energy configuration. In this manner, images from two different energy spectra are received from each of the three beamlines 90a, 90b, 90c. Clearly other configurations are possible under the linear detector mode without departing from the intent of the invention. For example, other quantities of detectors 18 are possible and the like.

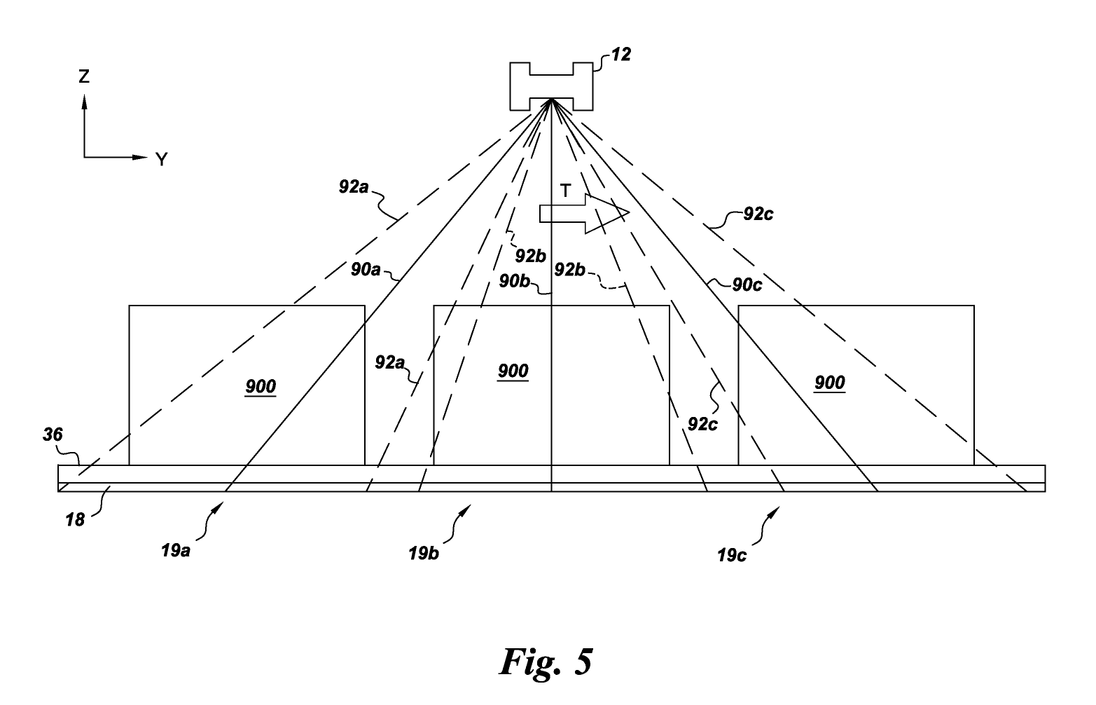

Referring to FIG. 5, the side elevation view depicts one X-ray source 12 capable of emitting a plurality of X-ray beams from various tomographic angles through the object 900 being transported by conveyor 36 in a direction of travel, T. The embodiment shown is in the area detector mode of operation. In this embodiment, the system 10 comprises a large area array detector 18 (or a plurality of abutted large area detectors 18) spaced along the path of travel, beneath the conveyor 36. The x-ray source 12 is configured to emit a plurality of x-ray beams in a cone beam 92 configuration from a variety of tomographic angles (i.e., tomo angles) towards the object 900 as it travels along the conveyor 36. As shown each X-ray “shot” comprises X-rays being emitted in a cone beam 92 configuration, having a beamline 90 therein, towards a region, or area, 19 of the area detector 18. For example, a first X-ray beam “shot”, in a cone beam 92a having a beamline 90a, from a first tomographic angle may be aimed at a first portion 19a of area detector 18. A second X-ray beam “shot”, in a cone beam 92b having a beamline 90b, from a second tomographic angle may be aimed at a second portion 19b of area detector 18. A third X-ray beam “shot”, in a cone beam 92c having a beamline 90c, from a third tomographic angle may be aimed at a third portion 19c of area detector 18. The mode may further include the ability of the X-ray source 12 to intermittently emit X-ray beams in at least two different energy spectra or the large area detector(s) 18 has a dual energy configuration. In this manner, images from two different energy spectra are received from each of the beamlines 90 shot. Clearly other configurations are possible under the area detector mode without departing from the intent of the invention.

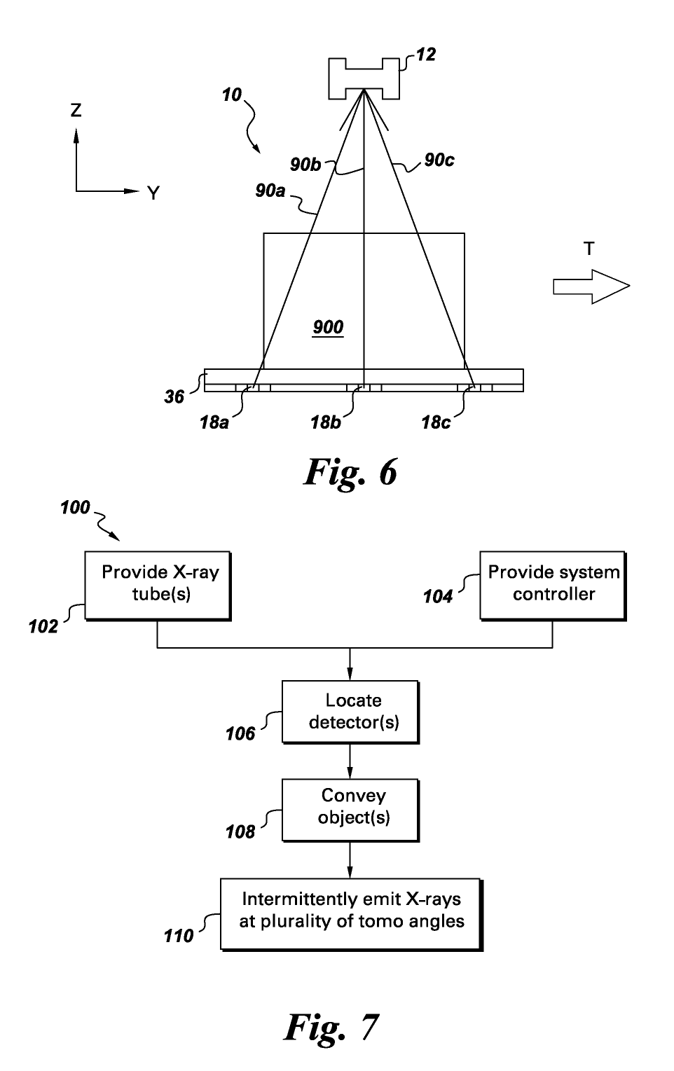

Referring to FIG. 6, the side elevation view depicts one X-ray source 12 capable of emitting a plurality of X-ray beams from various tomographic angles through the object 900 being transported by conveyor 36 in a direction of travel, T. The embodiment shown is in the area detector in linear detector mode of operation. In this embodiment, the system 10 comprises a large area array detector 18 (or a plurality of abutted large area detectors 18) spaced along the path of travel, beneath the conveyor 36. The large area array detector(s) 18 is treated as multiple adjacent, or abutted, linear detectors. That is the large area array detector(s) 18 is treated effectively treated an array of a plurality of one-detector element 50 deep detectors (i.e., linear detectors) abutted side-by-side transverse to the path of travel. The x-ray source 12 is configured to emit a plurality of x-ray beams from a variety of tomographic angles (i.e., tomo angles) towards the object 900 as it travels along the conveyor 36. For example, the X-ray source 12 may intermittently emit X-ray beams at tomo angles to correspond to every “effective” linear detector that makes up the large area array detector(s) 18. In other words, the X-ray source 12 may intermittently emit X-ray beams at each row of detector elements 50 as the object 900 passes along the conveyor. For example, as FIG. 6 shows, the X-ray source 12 may emit three “shots” to three specific rows of the area detector 18a, 18b, 18c. The mode may further include the ability of the X-ray source 12 to intermittently emit X-ray beams in at least two different energy spectra or the large area detector(s) 18 has a dual energy configuration. In this manner, images from two different energy spectra are received from each of the beamlines 90 shot. Clearly other configurations are possible under the linear detector mode without departing from the intent of the invention. For example, the X-ray source(s) may emit a “shot” for virtually any quantity of detector element 50 (FIG. 3A) rows that make up the area detector 18 along length (L) (See e.g., FIG. 3A).

Referring to FIG. 7, a flow chart of a method of imaging an object, in accordance with the present invention, is depicted. The method 100 includes at 102, providing at least one stationary X-ray tube 12, wherein the stationary X-ray tube 12 is configured to emit a cone beam of X-rays therefrom. At 104, a system controller configured to operate the x-ray tube(s) 12 is provided. At 106, at least one linear detector 18 or flat-panel area detector 18 is located opposite the X-ray tube 12. At 108, the object(s) 900 are conveyed through a field of view along a path of travel between the X-ray tube(s) 12 and detector(s) 18. Then, in 110, X-rays are emitted intermittently through the field of view and through the object in a plurality of tomographic angles.

In this manner aspects of the present invention are able to offer improvements over the related art, including the ability to provide better image quality, scan faster (e.g., the object 900 is over an individual pixel for a shorter time), have improved signal-to-noise, removal or reduction of gaps between adjacent tomo angle views, and the like.

It should be noted that embodiments of the invention are not limited to any particular computer for performing the processing tasks of the invention. The terms “computer”, “controller”, and “workstation” as those terms are used herein, is intended to denote any machines capable of performing the calculations, or computations, necessary to perform the tasks of the invention. The terms “computer”, “controller”, and “workstation” are intended to denote any machines that are capable of accepting a structured input and of processing the input in accordance with prescribed rules to produce an output. It should also be noted that the phrase “configured to” as used herein means that the computer(s), controller(s) and workstation(s) are equipped with a combination of hardware and software for performing the tasks of the invention, as will be understood by those skilled in the art.

The various embodiments of a tomosynthesis imaging system and method described herein thus provide a way to provide high performance imaging capability for access control of secure areas and/or medical applications. Further, the system and method may allow for a cost-effective means of providing a higher probability of detection coupled with a low false alarm rate as well as fast operation, a compact system footprint, adequate capital and low running costs, ease of use, and/or high reliability.

Therefore, according to one embodiment of the present invention, a method of imaging an object comprises: providing a stationary x-ray tube, wherein the stationary x-ray tube is configured to emit a cone beam of x-rays therefrom, further wherein a line extending from the stationary x-ray tube and through the object defines a tomographic angle, further wherein the stationary x-ray tube is configured to emits x-rays from a plurality of tomographic angles; providing a system controller configured to operate the stationary x-ray tube; locating one of a plurality of linear detectors and a flat-panel area detector opposite the stationary x-ray tube, thereby defining a field of view, wherein the plurality of linear detectors and a flat-panel area detector are configured to receive the emitted x-rays from the plurality of tomographic angles; conveying the object through the field of view along a path of travel; and intermittently emitting x-rays from the stationary x-ray tube in the plurality of tomographic angles through the object in the field of view.

According to another embodiment of the present invention, a method of imaging an object comprises: providing a stationary x-ray tube, wherein the stationary x-ray tube is configured to emit a cone beam of x-rays therefrom, further wherein a line extending from the stationary x-ray tube and through the object defines a tomographic angle and a beamline, further wherein the stationary x-ray tube is configured to emits x-rays from a plurality of tomographic angles; providing a system controller configured to operate the stationary x-ray tube; locating at least one flat-panel area detector opposite the stationary x-ray tube, thereby defining a field of view, wherein the at least one flat-panel area detector is configured to receive the emitted x-rays from the plurality of tomographic angles, further wherein the at least one flat-panel area detector comprises an array of L×W detector elements, wherein L is a length along a path of travel and W is a width transverse to the path of travel; conveying the object through the field of view along the path of travel; and selectively emitting x-rays from the stationary x-ray tube in the plurality of tomographic angles through the object in the field of view, wherein each beamline emitted from the stationary x-ray tube impinges on a different portion of the flat-panel area detector.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of imaging an object comprising:
providing a stationary x-ray tube, wherein the stationary x-ray tube is configured to emit a cone beam of x-rays therefrom, further wherein a line extending from the stationary x-ray tube and through the object defines a tomographic angle, further wherein the stationary x-ray tube is configured to emits x-rays from a plurality of tomographic angles;
providing a system controller configured to operate the stationary x-ray tube;
locating one of a plurality of linear detectors and a flat-panel area detector opposite the stationary x-ray tube, thereby defining a field of view, wherein the plurality of linear detectors and a flat-panel area detector are configured to receive the emitted x-rays from the plurality of tomographic angles;
conveying the object through the field of view along a path of travel; and
intermittently emitting x-rays from the stationary x-ray tube in the plurality of tomographic angles through the object in the field of view.

2. The method of claim 1 wherein the object comprises one of a human, an animal, and a man-made item.

3. The method of claim 2 wherein the man-made item comprises an article of luggage.

4. The method of claim 1 further wherein the stationary x-ray tube is configured to emit x-rays of at least two different energy spectra.

5. The method of claim 1, wherein the plurality of linear detectors are arranged transverse to the path of travel, further wherein the x-rays are emitted from the stationary x-ray tube towards each of the plurality of linear detectors as the object is conveyed over the plurality of linear detectors.

6. The method of claim 1, wherein the flat-panel area detector comprises a plurality of flat-panel area detectors.

7. The method of claim 1, wherein the plurality of linear detectors is configured transverse to the path of travel.

8. The method of claim 1, further comprising:
providing a second stationary x-ray tube, wherein the second stationary x-ray tube is configured to emit a cone beam of x-rays therefrom, further wherein a line extending from the second stationary x-ray tube and through the object defines a tomographic angle, further wherein the second stationary x-ray tube is configured to emits x-rays from a plurality of tomographic angles.

9. The method of claim 1, wherein the flat-panel area detector comprises a plurality of adjacently placed longitudinal one-dimensional arrays of detector elements, further wherein the x-rays are emitted from the stationary x-ray tube towards the flat-panel area detector intermittently as the object is conveyed over the plurality of adjacently placed longitudinal one-dimensional arrays of detector elements.

10. A method of imaging an object comprising:
providing a stationary x-ray tube, wherein the stationary x-ray tube is configured to emit a cone beam of x-rays therefrom, further wherein a line extending from the stationary x-ray tube and through the object defines a tomographic angle and a beamline, further wherein the stationary x-ray tube is configured to emits x-rays from a plurality of tomographic angles;
providing a system controller configured to operate the stationary x-ray tube;
locating at least one flat-panel area detector opposite the stationary x-ray tube, thereby defining a field of view, wherein the at least one flat-panel area detector is configured to receive the emitted x-rays from the plurality of tomographic angles, further wherein the at least one flat-panel area detector comprises an array of L×W detector elements, wherein L is a length along a path of travel and W is a width transverse to the path of travel;
conveying the object through the field of view along the path of travel; and
selectively emitting x-rays from the stationary x-ray tube in the plurality of tomographic angles through the object in the field of view, wherein each beamline emitted from the stationary x-ray tube impinges on a different portion of the flat-panel area detector.

11. The method of imaging an object of claim 10, wherein the different portion of the flat-panel area detector comprises a linear-shaped portion of the flat-panel area detector wherein a longitudinal portion of the linear-shaped portion is transverse the path of travel.

12. The method of imaging an object of claim 10, wherein the different portion of the flat-panel area detector are non-overlapping.

13. The method of imaging an object of claim 10, wherein the different portion of the flat-panel area detector comprises an array of 1×W detector elements, wherein W is a width of the flat-panel area detector transverse to the path of travel.

14. The method of imaging an object of claim 10, wherein the object comprises one of a human, an animal, and a man-made item.

15. The method of imaging an object of claim 10, wherein the stationary x-ray tube is configured to emit x-rays of at least two different energy spectra.
